(19) United States
(12) Patent Application Publication
(10) Pub. No.: US 2019/0365013 A1
(43) Pub. Date: Dec. 5, 2019

(54) LIGHT EMITTING VAMP HAVING GRADATIONAL VARIETY

(71) Applicant: Szu-Chi CHOU, TAICHUNG CITY (TW)

(72) Inventor: Szu-Chi CHOU, TAICHUNG CITY (TW)

(21) Appl. No.: 16/029,904

(22) Filed: Jul. 9, 2018

(30) Foreign Application Priority Data
May 30, 2018 (TW) 107207116

(51) Int. Cl. A43B 3/00; F21V 8/00; D02G 3/44

(52) U.S. Cl. CPC A43B 3/001; G02B 6/001; D10B 2501/043; D02G 3/44; D10B 2401/20; G02B 6/0006

(57) ABSTRACT

A light emitting vamp having gradational variety includes at least two light emitting units, a plurality of longitudinal yarns and a plurality of latitudinal yarns, which are woven with each other. Each of the light emitting units includes a plurality of fiber optic yams parallel to the latitudinal yarns. Each of the light emitting units has two light source conducting terminals formed in a way that two ends of all the fiber optic yams are bound up to be formed into the two light source conducting terminals. A light source can transmit light having variety to the fiber optic yarns through the light source conducting terminals. The light emitting units can emit light with different colors and provide different light emitting modes to make the vamp display much visual variation with gradational impression, enhance stereoscopic impression, abundance and fashion of the light and raise variety of visual effect.

### BACKGROUND OF THE INVENTION

### 1. Field of the Invention

The present invention relates to shoes and more particularly, to a light emitting vamp having gradational variety.

### 2. Description of the Related Art

Because the light emitting shoes are greater in visual effect than the traditional shoes, there are always a variety of light emitting shoes available for the consumers to purchase and wear. The simplest light emitting shoes are provided in the soles thereof with components capable of emitting light outwardly, so that the light can penetrate the soles to provide visual effect. In addition, some light emitting shoes are directly provided on the vamps thereof with LED light strips to achieve the light-emitting effect and color variation effect through the light emitted by the LED light strips.

However, the aforesaid light emitting shoes are relatively duller in light emitting effect. The light emitting effect is not desirable and unable to raise the fashion and variety of the shoes.

### SUMMARY OF THE INVENTION

Therefore, it is a primary objective of the present invention to provide a light emitting vamp for shoes, which can emit light having gradational impression, thereby enhanced in stereoscopic impression, abundance and fashion of the light and raised in variety of visual effect.

To attain the above objective, the present invention provides a light emitting vamp having gradational variety, which includes at least two light emitting units, a plurality of longitudinal yarns and a plurality of latitudinal yarns, which are woven with each other. Each of the at least two light emitting units includes a plurality of fiber optic yarns parallel to the latitudinal yarns. Each of the at least two light emitting units has two light source conducting terminals formed in a way that two ends of the fiber optic yarns are bound up to be formed into the two light source conducting terminals. It can be understood from the above description that the present invention uses a plurality of light emitting units to emit light with different colors and provide different light emitting modes, so that the vamp can display relatively more visual variation with gradational impression, thereby enhanced in stereoscopic impression, abundance and fashion of the light and raised in variety of visual effect.

Preferably, the fiber optic yarns of one of the at least two light emitting units and the latitudinal yarns are interwoven with the longitudinal yarns in a way that the fiber optic yarns and the latitudinal yarns are knitted together with the longitudinal yarns respectively and distributed evenly.

Preferably, the fiber optic yarns of one of the at least two light emitting units and the latitudinal yarns are arranged in a staggered manner along the extending direction of the longitudinal yarns.

Preferably, each of the light source conducting terminals is attached to an LED light source in a way that the LED light source is capable of transmitting light to the fiber optic yarns through the light source conducting terminal.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a perspective view of the appearance of a preferred embodiment of the present invention.

FIG. 2 is an exploded perspective view of the preferred embodiment of the present invention.

FIG. 3 is a partial schematic view of the preferred embodiment of the present invention.

FIG. 4 is a partial schematic view of the preferred embodiment of the present invention, primarily showing the constructive condition of a first light emitting unit.

FIG. 5 is a partial schematic view of the preferred embodiment of the present invention, primarily showing the constructive condition of a second light emitting unit.

FIG. 6 is a partial schematic view of another embodied type of the preferred embodiment of the present invention.

### DETAILED DESCRIPTION OF THE INVENTION

First of all, it is to be mentioned that the light emitting vamp having gradational variety provided by the present invention is widely applicable in various types of shoes. Those skilled in this field should understand that the illustrative phraseology in the detailed description of the invention belongs to a generic description of unlimited applicatory fields. For example, the phraseology of combination, connecting relation or weaving manner are used for example only. Besides, the meaning of the quantitative word “a (one)” for each element includes one and more than one or a plurality of elements.

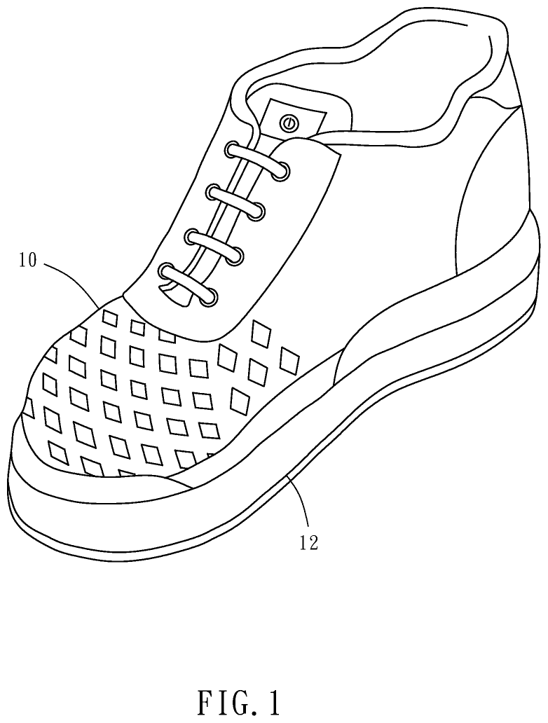

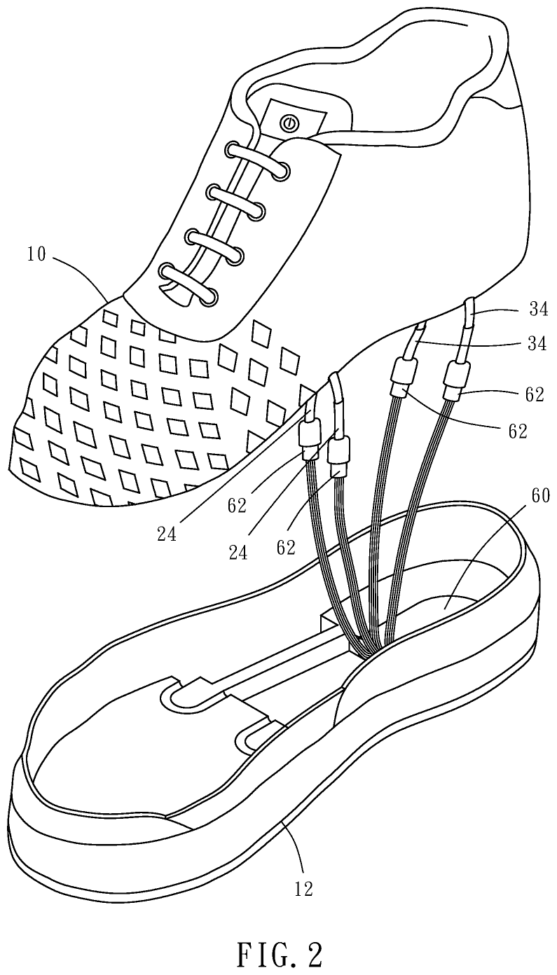

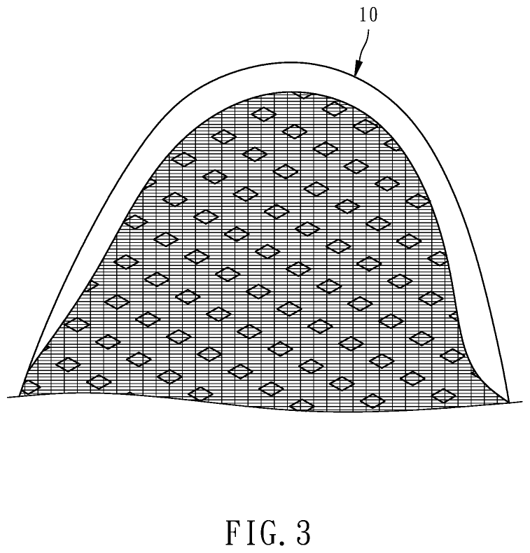

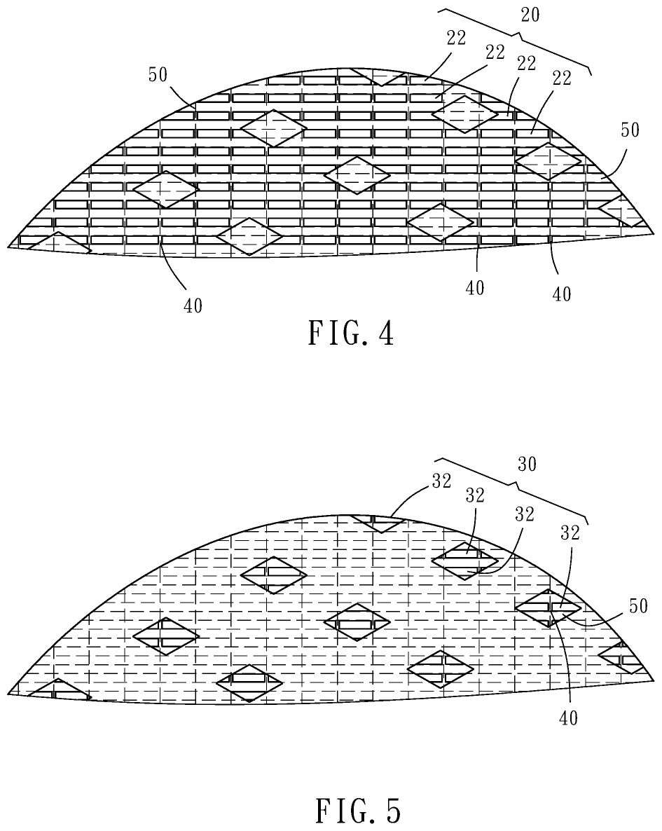

Referring to FIGS. 1-2, the light emitting vamp 10 having gradational variety provided by the present invention can be directly combined with a sole 12 and such combination can serve as the main structure of a shoe. Referring to FIGS. 3-5, the light emitting vamp 10 includes at least two light emitting units, a plurality of longitudinal yarns 40 and a plurality of latitudinal yarns 50, which are woven with each other. In this preferred embodiment, the at least two light emitting units include a first light emitting unit 20 and a second light emitting unit 30, for example. The first light emitting unit 20 and the second light emitting unit 30 include a plurality of first fiber optic yarns 22 and a plurality of second fiber optic yarns 32 respectively. In this preferred embodiment, the first fiber optic yarns 22, the second fiber optic yarns 32 and the latitudinal yarns 50 are interwoven with the longitudinal yarns 40 in a way that the fiber optic yarns 22 and 32 and the latitudinal yarns 50 are knitted together with the longitudinal yarns 40 respectively and distributed evenly. The first fiber optic yarns 22 and the second fiber optic yarns 32 are all parallel to the latitudinal yarns 50. The latitudinal yarns 50 and the first and second fiber optic yarns 22 and 32 are arranged in a staggered manner along the extending direction of the longitudinal yarns 40. The longitudinal yarns 40 and the latitudinal yarns 50 may be optionally made of chemical fiber, animal fiber or vegetable fiber.

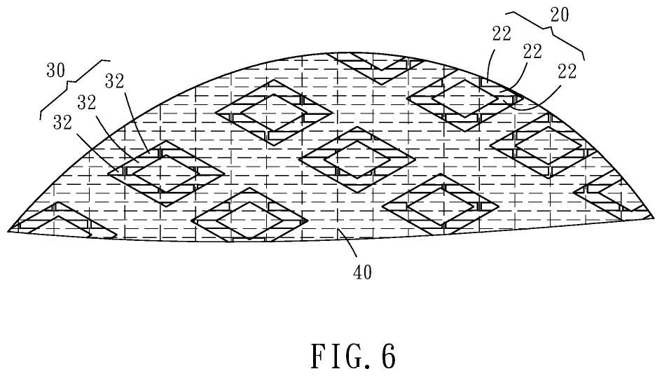

Besides, in the present invention the distributive mode of the light emitting units 20 and 30 can be modified according to the usage requirements. For example, as shown in FIG. 6, the first fiber optic yarns 22 and the second fiber optic yarns 32 may be distributed in specific partial regions of the vamp in a continuously arranged manner, such as being centralized at the shoe last part or the heelpiece part. In this way, the light emitting effect is relatively more flexible in variation and provides concentrative visual impression.

As shown in FIG. 2, the first light emitting unit 20 has two first light source conducting terminals 24 formed in a way that two ends of the first fiber optic yarns 22 are bound up to be formed into the two first light source conducting terminals 24; the second light emitting unit 30 has two second light source conducting terminals 34 formed in a way that two ends of the second fiber optic yarns 32 are bound up to be formed into the two second light source conducting terminals 34. The first light source conducting terminals 24 and the second light source conducting terminals 34 all extend out from the bottom of the vamp 10 to be connected to a light source module 60. The light source module 60 has a plurality of LED light sources 62 capable of emitting light with different colors. The LED light sources 62 correspond to the first light source conducting terminals 24 and the second light source conducting terminals 34 in a way that the LED light sources 62 can provide many different types of light emitting modes by being controlled, such as durative single-colored light without flash, single-colored light with flash, or at least two colors of light by turns.

It can be understood from the above description that the light emitting vamp 10 provided by the present invention uses the first light emitting unit 20 and the second light emitting unit 30 to emit light with different colors and provide different light emitting modes, so that the vamp 10 can display relatively more visual variation. Besides, the first fiber optic yarns 22 and the second fiber optic yarns 32 have vertically staggered depth difference therebetween, so that the light emitted by the first light emitting unit 20 and the second light emitting unit 30 can further provide the mixed light effect, which accompanying with the LED light sources 62 can provide many different types of light emitting modes, thereby improving the present invention in gradational impression thereof to achieve the technical effect of enhancement in stereoscopic impression, abundance and fashion of the light and raise in variety of visual effect.

1. A light emitting vamp having gradational variety, the light emitting vamp comprising at least two light emitting units, a plurality of longitudinal yams and a plurality of latitudinal yarns, which are woven with each other, each of the at least two light emitting units comprising a plurality of fiber optic yarns parallel to the latitudinal yarns, each of the at least two light emitting units having two light source conducting terminals formed in a way that two ends of the fiber optic yarns are bound up to be formed into the two light source conducting terminals;
wherein the at least two light emitting units emit light with different colors and light emitting modes.

2. The light emitting vamp as claimed in claim 1, wherein the fiber optic yarns of one of the at least two light emitting units and the latitudinal yarns are interwoven with the longitudinal yarns in a way that the fiber optic yarns and the latitudinal yarns are knitted together with the longitudinal yarns respectively and distributed evenly.

3. The light emitting vamp as claimed in claim 1, wherein the fiber optic yarns of one of the at least two light emitting units and the latitudinal yarns are arranged in a staggered manner along extending direction of the longitudinal yarns.

4. The light emitting vamp as claimed in claim 1, wherein the fiber optic yarns of one of the at least two light emitting units are distributed in a partial region in a continuously arranged manner.

5. The light emitting vamp as claimed in claim 1, wherein each of the light source conducting terminals is attached to an LED light source in a way that the LED light source is capable of transmitting light to the fiber optic yarns through the light source conducting terminal.
